(19) United States
(12) Patent Application Publication
(10) Pub. No.: US 2021/0357722 A1
(43) Pub. Date: Nov. 18, 2021

(54) ELECTRONIC DEVICE AND OPERATING METHOD FOR PERFORMING OPERATION BASED ON VIRTUAL SIMULATOR MODULE

(71) Applicant: SAMSUNG ELECTRONICS CO., LTD., Suwon-si (KR)

(72) Inventors: Seowoo JANG, Suwon-si (KR); Taejeoung KIM, Suwon-si (KR); Juhwan SONG, Suwon-si (KR); Taeseop LEE, Suwon-si (KR); Minsuk CHOI, Suwon-si (KR)

(21) Appl. No.: 17/320,885

(22) Filed: May 14, 2021

Related U.S. Application Data
(60) Provisional application No. 63/024,822, filed on May 14, 2020.

(30) Foreign Application Priority Data
Feb. 24, 2021 (KR) 10-2021-0025122

(51) Int. Cl. G06N 3/00; G06F 9/455; G06N 20/00

(52) U.S. Cl. CPC G06N 3/006; G06N 20/00; G06F 9/455

(57) ABSTRACT

Provided is a method, performed by an electronic device, of an operation based on a virtual simulator module, wherein the electronic device obtains a simulation parameter set for each of a plurality of operations for performing simulations with respect to the plurality of operations, obtains first performance information for each operation using a simulator module, wherein the first performance information indicates performance of an operation simulated based on the simulation parameter set, obtains second performance information for each operation based on the first performance information using a modeling module, wherein the second performance information indicates performance of the operation simulated in the simulator module, and performs an operation of the plurality of operations based on the first performance information and the second performance information.

### CROSS-REFERENCE TO RELATED APPLICATIONS

This application is based on and claims priority under 35 U.S.C. § 119 to U.S. Provisional Application No. 63/024,822, filed on May 14, 2020, in the US Patent and Trademark Office and Korean Patent Application No. 10-2021-0025122, filed on Feb. 24, 2021, in the Korean Intellectual Property Office, the disclosures of which are incorporated by reference herein in their entireties.

### BACKGROUND

### 1. Field

The disclosure relates to an electronic device for performing an operation based on a virtual simulator module for virtually implementing a real operation and an operating method of the electronic device.

### 2. Description of the Related Art

A virtual simulator module may refer to a module for predicting real data, which may be obtained from a real environment, by virtually implementing a real world and performing a preset operation.

Virtual simulator modules in the related art may predict a result of performing an actual operation by virtually implementing a virtual environment using a function including various types of preset parameters. For example, a size of a block of data, an encoding rate, a modulation sequence, a channel state, and the like, which are transmitted over a network, are input to a virtual simulator module such that a network environment in which data is virtually transmitted is implemented, and thus, a data transmission error rate may be predicted.

However, because a real environment may continuously change due to various factors, there may be a case in which it is inappropriate for the virtual simulator module to use a fixed parameter to implement a virtual environment.

### SUMMARY

Embodiments of the disclosure provide an electronic device for performing an operation based on a virtual simulator module for virtually implementing a real operation and a method of operating the electronic device.

Embodiments of the disclosure also provide a non-transitory computer-readable recording medium having recorded thereon a program for executing the method on a computer. The disclosure is not limited to the above aspects, and there may be other aspects of the disclosure.

Additional aspects will be set forth in part in the description which follows and, in part, will be apparent from the description.

According to an example embodiment of the disclosure, a method, performed by an electronic device, of performing an operation, based on a virtual simulator module is provided, the method including: obtaining a simulation parameter set for each of a plurality of operations for performing simulations with respect to the plurality of operations; obtaining first performance information for each operation using a simulator module, wherein the first performance information indicates performance of an operation simulated based on the simulation parameter set; obtaining second performance information for each operation based on the first performance information using a modeling module, wherein the second performance information indicates the performance of the operation simulated in the simulator module; and performing an operation of the plurality of operations, based on the first performance information and the second performance information.

According to an example embodiment of the disclosure, an electronic device configured to perform an operation based on a virtual simulator module, the electronic device including: a memory storing one or more instructions; and at least one processor configured to execute the one or more instructions stored in the memory to control the electronic device to: obtain a simulation parameter set for each of a plurality of operations for performing simulations with respect to the plurality of operations, obtain first performance information for each operation using a simulator module, wherein the first performance information indicates performance of an operation simulated based on the simulation parameter set, obtain second performance information for each operation based on the first performance information using a modeling module, wherein the second performance information indicates the performance of the operation simulated in the simulator module, and perform an operation of the plurality of operations, based on the first performance information and the second performance information.

According to an example embodiment of the disclosure, a non-transitory computer-readable recording medium having stored thereon a program for performing the method according to an example embodiment of the disclosure is provided.

### BRIEF DESCRIPTION OF THE DRAWINGS

The above and other aspects, features, and advantages of certain embodiments of the present disclosure will be more apparent from the following detailed description, taken in conjunction with the accompanying drawings, in which:

FIG. 1 is a diagram illustrating an example of performing an operation based on a result of performing a simulation in a virtual environment, according to various embodiments;

FIG. 2 is a block diagram illustrating an example of performing an operation based on a virtual simulator module, according to various embodiments;

FIG. 3 is a diagram illustrating an example of a virtual simulator module, according to various embodiments;

FIG. 4 is a block diagram illustrating an example configuration of an electronic device, according to various embodiments;

FIG. 5 is a block diagram illustrating an example configuration of an electronic device, according to various embodiments;

FIG. 6 is a flowchart illustrating an example method of performing an operation based on a virtual simulator module, according to various embodiments;

FIG. 7 is a diagram illustrating an example of simulating an operation of a network environment, according to various embodiments;

FIG. 8 is a diagram illustrating an example of simulating an operation of a network environment, according to various embodiments;

FIG. 9 is a diagram illustrating an example of detecting an error rate for a data transmission operation of a virtual environment using a virtual simulator module, according to various embodiments;

FIG. 10 is a diagram illustrating an example of detecting an error rate for an operation of a virtual environment using a virtual simulator module, according to various embodiments;

FIG. 11 is a diagram illustrating an example of predicting a parameter set using a virtual simulator module, according to various embodiments; and

FIG. 12 is a diagram illustrating an example of obtaining a parameter combination for predicting a parameter set, according to various embodiments.

### DETAILED DESCRIPTION

Hereinafter, various example embodiments of the disclosure will be described in greater detail with reference to the accompanying drawings. However, it should be understood that the disclosure may be embodied in different ways and is not limited to embodiments described herein. In addition, portions irrelevant to the description may be omitted from the drawings for clarity, and like components are denoted by like reference numerals throughout the specification.

Throughout the disclosure, the expression “at least one of a, b or c” indicates only a, only b, only c, both a and b, both a and c, both b and c, all of a, b, and c, or variations thereof.

Throughout the disclosure, when an element is referred to as being “connected to” another element, the element may be “directly connected to” the other element, or the element may also be “electrically connected to” the other element with an intervening element therebetween. In addition, when an element is referred to as “including” or “comprising” another element, unless otherwise stated, the element may further include or comprise yet another element rather than preclude the yet other element.

Functions related to artificial intelligence according to the disclosure are operated through a processor and a memory. The processor may include at least one processor. In this regard, the at least one processor may include, for example, and without limitation, at least one of a general-purpose processor such as a central processing unit (CPU), an application processor (AP), or a digital signal processor (DSP), a dedicated graphics processor such as a graphics processing unit (GPU) or a vision processing unit (VPU), or an artificial intelligence-dedicated processor such as a neural processing unit (NPU). The at least one processor may be controlled to process input data according to a predefined operation rule stored in the memory or an artificial intelligence model. When the at least one processor is an artificial intelligence-dedicated processor, the artificial intelligence-dedicated processor may be designed in a hardware structure specialized for processing a specific artificial intelligence model.

The predefined operation rule or the artificial intelligence model are made through training. The expression “made through training” may refer, for example, to an existing artificial intelligence model being trained based on a learning algorithm using a large number of pieces of training data and thus made into a predefined operation rule or an artificial intelligence model, which is set to fulfill an intended feature (or purpose). The training may be performed by a device itself, in which artificial intelligence according to the disclosure is performed, or may be performed through a separate server and/or system. Examples of the learning algorithm include supervised learning, unsupervised learning, semi-supervised learning, and reinforcement learning, but are not limited thereto.

An artificial intelligence model may include a plurality of neural network layers. Each of the neural network layers has a plurality of weight values and performs a neural network operation through an operation between an operation result of a previous layer and the plurality of weight values. The plurality of weight values that the neural network layers have may be optimized by a result of training of the artificial intelligence model. For example, the plurality of weight values may be refined to minimize and/or reduce a loss value or cost value obtained by the artificial intelligence model during a training process. An artificial neural network may include, for example, and without limitation, at least one of a deep neural network (DNN), and may be, for example, a convolutional neural network (CNN), a deep neural network (DNN), a recurrent neural network (RNN), a restricted Boltzmann machine (RBM), a deep belief network (DBN), a bidirectional recurrent deep neural network (BRDNN), or a deep Q-network, but is not limited thereto.

Hereinafter, the disclosure will be described in greater detail with reference to the accompanying drawings.

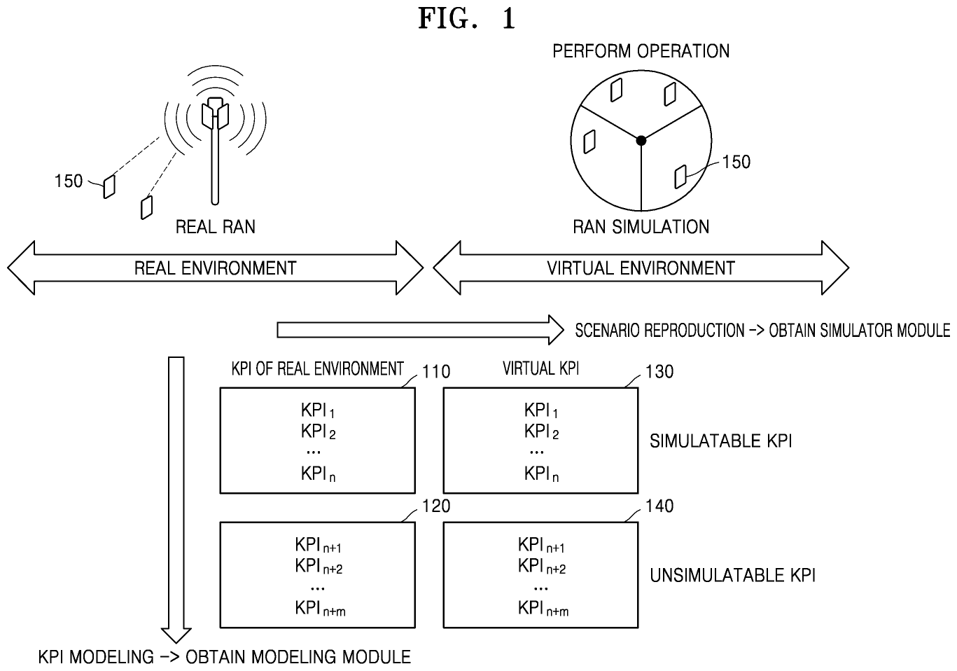

FIG. 1 is a diagram illustrating an example of performing an operation based on a result of performing a simulation in a virtual environment, according to various embodiments.

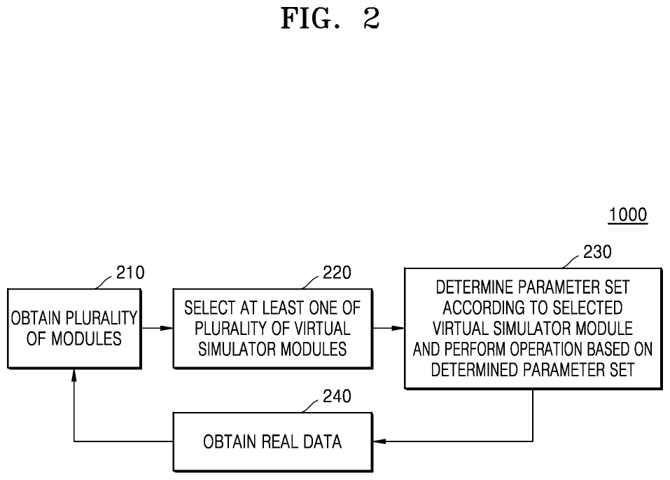

Referring to FIG. 1, an electronic device 1000 (refer to FIG. 2) according to an embodiment of the disclosure may select an operation to be actually performed from among a plurality of operations, based on a result of performing a simulation for each of the operations in a virtual environment.

The electronic device 1000 according to an embodiment of the disclosure may select an operation to be actually performed from among a plurality of operations simulated in a virtual environment, based on an input key performance indicator (KPI) 130 and a target KPI 140, each indicating performance of each of the operations.

A KPI according to an embodiment of the disclosure may include various types of information indicating performance of an operation. According to an embodiment of the disclosure, the KPI may be sorted into input KPIs including an input KPI 110 and an input KPI 130 and target KPIs including a target KPI 120 and a target KPI 140, according to whether acquisition by a simulator module is possible or not.

The input KPI 130 according to an embodiment of the disclosure may be obtained by a simulator module performing a simulation based on a simulation parameter set for performing an operation. For example, the input KPI 130 may include the number of radio resource control (RRC)-connected user entities (UEs), a utilization factor of a physical resource block (RB), internet protocol (IP) layer throughput per UE, a downlink traffic volume at L2, and the like.

The input KPI 130 is not limited to examples described above and may include at least one KPI that may be obtained by a simulator module based on various simulation parameters (e.g., a packet size, a packet request interval, a hotspot distance ratio, and a hotspot UE ratio) that may be observed in a real environment.

The target KPI 140 according to an embodiment of the disclosure includes performance information represented by a superordinate concept to the input KPI 130 or a probability, and thus, may not be directly obtained by the simulator module, and may be obtained by a modeling module based on the input KPI 130 obtained by the simulator module. For example, the target KPIs 120 and 140 may include a rate of an RRC drop event, a rate of a handover fail event, a rate of a session setup fail event, and the like.

The disclosure is not limited to examples described above, and the target KPI 140 may include various types of performance information which is difficult to be directly obtained by the simulator module based on the simulation parameter set.

The electronic device 1000 according to an embodiment of the disclosure may obtain a simulator module and a modeling module through scenario reproduction and KPI modeling, respectively.

The modeling module according to an embodiment of the disclosure may include various processing circuitry and/or executable program elements and may include a module including an artificial intelligence model, a function, and the like, which may output a target KPI set including at least one target KPI 120 based on an input KPI set including at least one input KPI 110. The modeling module according to an embodiment of the disclosure may be trained based on training data including a pair of the input KPI set and the target KPI set, each obtained in a real environment.

The training data according to an embodiment of the disclosure may include at least one input KPI 110 as input information and may include at least one target KPI 120 as output information.

However, input KPI values or target KPI values, from among information included in the training data according to an embodiment of the disclosure, are not evenly distributed over all ranges and may have values biased to some ranges. For example, because a phenomenon where radio control access is dropped rarely occurs, a rate of an RRC drop event (hereinafter, referred to as an “RRC drop rate”) in the target KPI 120 may have, as training data, most of values close to 0, the values being collected from a real environment. However, according to the training data having the values biased to some ranges, performance of an artificial intelligence model may deteriorate.

Therefore, according to an embodiment of the disclosure, the number of KPI values may be increased through up-sampling, wherein the KPI values from among KPI values collected as training data belong to a range where the number of pieces of data is small.

For example, when a minimum value and maximum value of values of the RRC drop rate are 0% and 100%, respectively, each of ranges of 0 to 2% and 2 to 20% may be divided into ten ranges and a range of 20 to 100% may be divided into four ranges, and up-sampling may be performed on a value of the RRC drop rate, wherein the value belongs to a range, from among the ranges, where the number of values collected as training data is less than or equal to a reference value. Also, according to characteristics (where many values are close to 0) of distribution of values of the RRC drop rate, 0-2% and 2-20%, which are ranges close to 0, may be divided into a larger number of ranges than what 20-100% may be divided into.

For example, when the number of values of the RRC drop rate, the values belonging to a range of 0.2 to 0.4%, is less than or equal to a reference value, up-sampling is performed based on a value of the RRC drop rate, the value belonging to the range of 0.2 to 0.4%, whereby new training data may be generated. Based on the existing values of the RRC drop rate, the values belonging to the range of 0.2 to 0.4%, the new training data may be generated by including a newly generated value of the RRC drop rate, the value belonging to the range of 0.2 to 0.4%.

According to an embodiment of the disclosure, a value of the RRC drop rate may be newly generated based on a value obtained by a simple copy of a value of the RRC drop rate or a value obtained by performing linear interpolation between values of the RRC drop rate (e.g., synthetic minority oversampling technique (SMOTE). The disclosure is not limited to the examples described above, and according to various methods for removing bias in training data, new training data may be generated.

The input KPI set included in the training data according to an embodiment of the disclosure may be expressed as a vector value in which different input KPI values are in different dimensions. Similarly, the target KPI set may also be expressed as a vector value in which different target KPI values are in different dimensions. The disclosure is not limited to examples described above, and the input KPI set and the target KPI set may be expressed according to various methods.

Different vector values respectively indicating a plurality of input KPI sets are mapped to a same or similar vector value of a target KPI set, and there may be a problem in that a result of the mapping is obtained as training data. Similarly, same or similar vector values of an input KPI set are mapped to different vector values of a plurality of target KPI sets, respectively, and a result of the mapping may be obtained as training data. For example, when a target KPI set or an input KPI set includes KPIs having most of values in a small range such as the RRC drop rate, a difference between respective KPI values is not large, resulting in confusion in training data.

The disclosure is not limited to a case where a KPI set is expressed as a vector value described above, and the same problem may exist for training data including a KPI set expressed by various methods. In this case, due to inconsistency in the training data, the performance of the modeling module which is trained based on the training data may be problematic.

Therefore, according to an embodiment of the disclosure, in the same or similar manner as in a case where a KPI value is up-sampled, a range of a minimum value to a maximum value of respective KPI values may be adaptively divided into a plurality of ranges according to distribution characteristics of each KPI value, and each of the ranges may be labeled. For example, a range, from among ranges of KPI values, where the number of pieces of data is large, is divided into a smaller range and may be labeled. Therefore, because each of the KP values of training data may be replaced with a labeled value according to a probabilistic frequency, the problem of confusion in the training data may be resolved.

Based on the scenario reproduction according to an embodiment of the disclosure, an operation for obtaining the simulator module may be performed.

The simulator module according to an embodiment of the disclosure may include various processing circuitry and/or executable program elements, including an artificial intelligence model and function that may output at least one input KPI 130 based on at least one simulation parameter.

According to an embodiment of the disclosure, at least one simulation parameter, which is most suitable for outputting the input KPIs 110 and 130, from among a plurality of different simulation parameters may be determined. According to an embodiment of the disclosure, a simulation parameter, which is directly related to variation of values of the input KPIs 110 and 130, from among simulation parameters may be used for a simulation. The simulator module according to an embodiment of the disclosure may output the input KPI 130 based on the determined simulation parameter.

At least one simulation parameter for simulating the input KPI 130 according to an embodiment may be determined as a value at which the input KPI 130 obtained by the simulator module is most similar to the actually observed input KPI 110. The disclosure is not limited to examples described above, and a simulation parameter may be determined according to various methods.

The simulator module according to an embodiment of the disclosure may be obtained based, for example and without limitation, on particle swarm optimization (PSO) or a reinforcement learning, without supervised learning based on training data. The PSO may refer, for example, to an algorithm that may obtain a finally optimized value by simultaneously improving candidate values through iterative calculations. Also, the reinforcement learning is a training method for improving the simulator module without training data according to a result of determination on whether a simulation result (e.g., an input KPI) is good or bad.

The disclosure is not limited to examples described above, and the simulator module may be trained or obtained according to various methods to output the input KPI as a simulation result based on a simulation parameter.

According to an embodiment of the disclosure, based on the input KPI 130 predicted according to the scenario reproduction, the target KPI 140 of a virtual environment is determined according to the KPI modeling, and based on at least one of the input KPI 130 or the target KPI 140, an operation may be performed. For example, based on at least one of the input KPI 130 or the target KPI 140, each obtained with respect to each of a plurality of operations, one operation may be determined, and an operation that is finally determined may be performed.

The plurality of operations according to an embodiment of the disclosure may include an operation, performed by a user entity 150, of accessing a carrier for accessing a wireless network. According to an embodiment of the disclosure, the operation, performed by the user entity 150, of accessing a network by selecting each of a plurality of carriers is simulated through the modeling module and the simulator module, whereby a carrier enabling the user entity 150 to access a wireless network may be selected from among the plurality of carriers.

The user entity 150 according to an embodiment of the disclosure may be the same device as the electronic device 1000 performing a simulation according to the modeling module and the simulator module, but is not limited thereto, and may be different from the electronic device 1000. For example, the user entity 150 may receive, from the electronic device 1000, a result of selecting a carrier, and based on the result, may access a wireless network.

According to an embodiment of the disclosure, a simulation parameter value may be determined with respect to each of the carriers, and based on the input KPI 130 obtained by the simulator module, the target KPI 140 may be obtained by the modeling module.

For example, a penalty may be imposed on a carrier having a value of the RRC drop rate being greater than or equal to a reference value from among the carriers, and a probability in which the carrier is to be selected may decrease. In addition to the RRC drop rate, based on another value of the target KPI 140, a penalty may be imposed on each carrier. Also, a carrier to be connected to the user entity 150 may be selected from among carriers having IP throughput of the input KPI 130 being greater than or equal to a reference value.

The user entity 150 to access a network according to an embodiment of the disclosure may perform communication in an optimum network environment by accessing the network via the selected carrier.

FIG. 2 is a block diagram illustrating an example of performing an operation based on a virtual simulator module, according to various embodiments.

Referring to FIG. 2, the electronic device 1000 according to an embodiment of the disclosure may obtain, from among a plurality of virtual simulator modules, a virtual simulator module suitable for implementing a virtual environment based on real data obtained in a real environment.

Referring to FIG. 2, unlike in FIG. 1, without determining a modeling module or performance information, a parameter set may be determined based on a result of a simulation performed by a virtual simulator module, and an operation may be performed according to the determined parameter set. Therefore, according to FIG. 2, unlike in FIG. 1, based on a simulation parameter set, the performance information (e.g., a target KPI) that may not be obtained by the simulator module may not be used.

The real data according to an embodiment of the disclosure represents data collected from a real environment. For example, when the virtual simulator module is a module for predicting a data transmission error rate, the real data may include information about an error rate of data that is actually transmitted. The disclosure is not limited to examples described above, and the real data may include various types of data that may be collected from a real environment, in relation to information that may be predicted by the virtual simulator module.

The virtual simulator module according to an embodiment of the disclosure may implement an operation in a virtual environment based on an input value, and may obtain an output value based on the implemented operation. The input value according to an embodiment of the disclosure may include, for example, a size of a block of data, an encoding rate, a state of transmission channel, a modulation sequence, and the like, as parameters for implementing a virtual environment. The output value according to an embodiment of the disclosure may include, for example, information about a data transmission error rate, as information related to a result of an operation performed in a virtual environment implemented according to situation information.

According to an embodiment of the disclosure, an input value at which an optimum value may be output as an output value by the virtual simulator module may be obtained. According to an embodiment of the disclosure, a condition for performing an operation in a real environment is set according to the obtained input value, whereby the operation by which an optimum result may be obtained may be performed.

For example, when the virtual simulator module is a module for predicting a data transmission error rate, a data transmission error rate may be obtained based on a parameter set for implementing a data transmission operation. Also, based on different parameter sets, a data transmission error rate corresponding to each of the parameter sets may be obtained by the virtual simulator module, and a parameter set at which a data transmission error rate may be reduced may be finally determined.

According to an embodiment of the disclosure, because an operation is performed according to the finally determined parameter set, an optimum result may be obtained.

According to an embodiment of the disclosure, to obtain a data transmission error rate without the virtual simulator module, an operation for actually transmitting/receiving data and determining an error rate from the actually transmitted/received data should be performed. Therefore, to obtain a parameter set at which the data transmission error rate may be reduced, a data transmission operation should be performed according to different parameter sets, whereby a considerable amount of computation and time may be required.

However, when the virtual simulator module according to an embodiment of the disclosure is used, virtually implemented data transmission operations according to different parameter sets may be performed several times without performing an operation of actually transmitting data. Therefore, according to an embodiment of the disclosure, when the virtual simulator module is used, an error rate for a data transmission operation performed according to different parameter sets may be predicted with a small amount of computation for a short period of time.

According to an embodiment of the disclosure, the electronic device 1000 may determine a parameter set for a transmission operation for transmitting data with a minimum error rate in a real environment may be determined based on the error rate predicted with a fast and small amount of computation using the virtual simulator module. For example, the electronic device 1000 may perform an operation of actually transmitting data according to a parameter set for a transmission operation, the parameter set corresponding to a minimum error rate from among error rates predicted by the virtual simulator module.

However, according to an embodiment of the disclosure, a real environment corresponding to a virtual environment implemented by the virtual simulator module may be continuously changed. In response to the real environment being changed, a result of an operation performed in the real environment based on a same parameter set may be different from a result of an operation performed in a virtual environment by the virtual simulator module.

Therefore, according to an embodiment of the disclosure, the virtual simulator module may be refined to implement a virtual environment that is the same as or similar to a real environment, based on real data (e.g., an error rate for a data transmission operation) obtained from the real environment. For example, a configuration of the virtual simulator module may be modified to minimize and/or reduce a difference between an error rate for a data transmission operation obtained from the real environment based on a same parameter set and an error rate output by the virtual simulator module.

According to an embodiment of the disclosure, a virtual simulator module capable of implementing a virtual environment most similar to a real environment is selected from among a plurality of virtual simulator modules, and the selected virtual simulator module may be used to determine a parameter set.

Although the plurality of virtual simulator modules according to an embodiment of the disclosure are trained based on same training data, results refined according to training may be different from each other. Because each of the virtual simulator modules may be trained to probabilistically output a value of training data, parts of which are changed in a configuration of each of the virtual simulator modules may be different according to the training.

Therefore, according to an embodiment of the disclosure, a plurality of virtual simulator modules may output different output values based on a same parameter set. According to an embodiment of the disclosure, a virtual simulator module outputting an output value most similar to real data collected from a real environment from among output values is selected and may be used to virtually implement an operation of the real environment.

The electronic device 1000 according to an embodiment of the disclosure may include devices that may be implemented in various forms capable of obtaining a virtual simulator module based on real data. For example, the electronic device 1000 described herein may include, but is not limited to, a digital camera, a smart phone, a laptop computer, a tablet personal computer (PC), an electronic book (e-book) terminal, a digital broadcasting terminal, a personal digital assistant (PDA), a portable multimedia player (PMP), a navigation system, an MP3 player, a vehicle, or the like. The electronic device 1000 described herein may include a wearable device that may be worn by a user. The wearable device may include, but is not limited to, at least one of an accessory type device (for example, a watch, a ring, a wristband, an ankle band, a necklace, glasses, or contact lenses), a head-mounted device (HMD), a fabric or clothing-integrated device (for example, electronic clothes), a body-attached device (for example, a skin pad), or a bio-implantable device (for example, an implantable circuit).

In operation 210, the electronic device 1000 according to an embodiment of the disclosure may obtain a plurality of virtual simulator modules based on real data obtained from a real environment. For example, the electronic device 1000 may obtain, as training data, a parameter set corresponding to the real data, and may obtain a virtual simulator module trained based on the training data. Also, the electronic device 1000 may obtain a plurality of virtual simulator modules by performing training based on same training data with respect to a same virtual simulator module multiple times. Training of an artificial intelligence model according to an embodiment of the disclosure is refined by arbitrarily modifying components of the artificial intelligence model to output an input value and an output value according to training data, and thus even when artificial intelligence models are trained based on same training data, the artificial intelligence models may include different components.

The virtual simulator module according to an embodiment of the disclosure may virtually implement an operation in a real environment, and may output at least one output value related to a result of performing the operation.

The electronic device 1000 according to an embodiment of the disclosure may obtain, through the virtual simulator module, a parameter set from which an optimum output value may be obtained and which is an input value of the virtual simulator module. For example, the electronic device 1000 may obtain a parameter set corresponding to a lowest error rate value from among at least one error rate value of a transmission operation, wherein the parameter set is an input value of the virtual simulator module and the lowest error rate value is an output value of the virtual simulator module.

Therefore, the electronic device 1000 according to an embodiment of the disclosure may obtain a parameter set for a data transmission operation through the virtual simulator module, without actually performing the data transmission operation multiple times according to different parameter sets, wherein a lowest data transmission error rate may be obtained from the parameter set.

The electronic device 1000 according to an embodiment of the disclosure may rapidly determine a parameter set of the data transmission operation with a small amount of computation using the virtual simulator module, and may perform the data transmission operation in a real environment.

The parameter set according to an embodiment of the disclosure may include various parameter values that may affect an operation being performed, such as a parameter for configuring an operation (e.g., a set value included in a transmission operation and for adjusting an error in data).

The real data according to an embodiment of the disclosure may include data collected in relation to an operation performed in a real environment. For example, real data collected in relation to an operation of predicting an error rate of data transmission may include a parameter set of a data transmission operation, which is an input value for implementing the data transmission operation, and a data transmission error rate, which is an output value corresponding to the input value.

The virtual simulator module according to an embodiment of the disclosure may implement a virtual operation through a function or a pre-trained artificial intelligence model. When the virtual simulator module according to an embodiment of the disclosure is a module for implementing an operation through a function, the virtual simulator module may be generated by modifying at least one variable included in the function or a configuration of the function (e.g., a formula structure) based on real data. For example, in response to an input value according to real data being input to the virtual simulator module, at least one variable may be determined to output an output value of the real data corresponding to the input value.

When the virtual simulator module according to an embodiment of the disclosure may implement a virtual operation through a pre-trained artificial intelligence model, the artificial intelligence model is modified to output an output value based on an input value according to real data, whereby a virtual simulator module generated in operation 210 may be obtained. For example, in the artificial intelligence model, a weight value for each node, a bias value, a node structure, or the like of the artificial intelligence model are modified based on the real data, whereby an artificial intelligence model modified based on the real data may be obtained.

In operation 220, the electronic device 1000 according to an embodiment of the disclosure may select at least one virtual simulator module from among the plurality of virtual simulator modules obtained in operation 210. According to an embodiment of the disclosure, the electronic device 1000 may select a virtual simulator module suitable for implementing an operation to be performed, by evaluating each of the plurality of virtual simulator modules.

The electronic device 1000 according to an embodiment of the disclosure may evaluate each of the virtual simulator modules based on whether each of the virtual simulator modules output, as real data, an output value having a least difference from real data. The electronic device 1000 according to an embodiment of the disclosure may obtain at least one real data obtained from a real environment to evaluate the plurality of virtual simulator modules. Also, real data for evaluating a virtual simulator module may be obtained from the real environment based on an operation, in which data is transmitted for evaluation according to an arbitrary parameter set. In response to the arbitrary parameter set being input to the plurality of virtual simulator modules, the electronic device 1000 according to an embodiment of the disclosure may determine and finally select, as a virtual simulator module with best performance, a virtual simulator module having a least difference between an output value and the real data obtained from the real environment.

According to an embodiment of the disclosure, the electronic device 1000 may evaluate the plurality of virtual simulator modules, according to various methods in addition to examples described above. For example, the electronic device 1000 may evaluate the plurality of virtual simulator modules according to various criteria such as a processing speed, complexity, and prediction accuracy for an output value of each of operations that may be implemented by a virtual simulator module. The disclosure is not limited to examples described above, and the electronic device 1000 evaluates the plurality of virtual simulator modules according to various methods to implement an optimum operation according to various parameter sets, that is, an input value, whereby the electronic device 1000 may select at least one virtual simulator module by which an optimum output value may be obtained.

According to an embodiment of the disclosure, operation 220 of selecting a virtual simulator module may be performed by a pre-trained artificial intelligence model. For example, a pre-trained artificial intelligence model may be used to obtain, from among the plurality of virtual simulator modules, a virtual simulator module by which an optimum operation may be implemented.

In operation 230, the electronic device 1000 according to an embodiment of the disclosure may determine a parameter set of an operation predicted to obtain an optimum result according to the at least one selected virtual simulator module, and may perform the operation based on the determined parameter set. According to an embodiment of the disclosure, the electronic device 1000 may determine a parameter set, at which an optimum output value may be obtained, by inputting, to the at least one virtual simulator module, various parameter sets for an operation to be currently performed. The electronic device 1000 according to an embodiment of the disclosure may perform the operation according to the determined parameter set.

For example, in a case of a virtual simulator module for predicting a data transmission error rate, the electronic device 1000 may determine situation information, by which a minimum error rate may be obtained, according to the virtual simulator module, and may perform an operation of transmitting data according to the determined situation information.

In operation 240, the electronic device 1000 according to an embodiment of the disclosure may obtain real data based on a result of the operation performed in operation 230. According to an embodiment of the disclosure, in operation 210, the plurality of virtual simulator modules may be refined based on the real data obtained in operation 240.

For example, in the case of the virtual simulator module for predicting a data transmission error rate, the electronic device 1000 may obtain, as the real data in operation 240, the parameter set and transmission error rate for the data transmission operation performed in operation 230.

Therefore, according to an embodiment of the disclosure, in response to a virtual simulator module adaptively modified based on real data obtained from a real environment being obtained, performance of the virtual simulator module may be further improved.

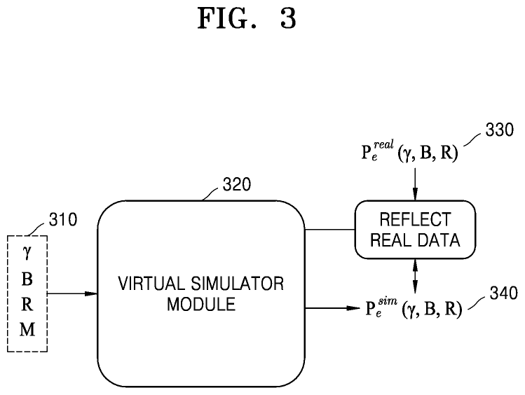

FIG. 3 is a diagram illustrating an example of a virtual simulator module, according to various embodiments.

Referring to FIG. 3, in response to an input value 310 being input to a virtual simulator module (e.g., including various processing circuitry and/or executable program elements) 320 according to an embodiment of the disclosure, an output value may be obtained.

According to an embodiment of the disclosure, in a case of the virtual simulator module 320 that outputs a value for predicting a data transmission error rate as an output value, the input value 310 of the virtual simulator module 320 may include at least one of values such as a channel state (γ), a size of a block of data (B), an encoding rate (R), a modulation sequence (M), and the like.

The channel state according to an embodiment of the disclosure is information about noise that may be included in data being transmitted in a channel, and may include, for example, information such as a signal to interference plus noise ratio (SINR) and a signal to noise ratio (SNR).

According to an embodiment of the disclosure, when a value 340 output in response to the input value 310 being input to the virtual simulator module 320 is compared with a value 330 as real data obtained by an operation performed in a real environment, the virtual simulator module 320 may be modified.

For example, the virtual simulator module 320 may be modified to minimize and/or reduce a difference between the error rate 340 predicted by the virtual simulator module 320 and the error rate 330 obtained according to a data transmission operation performed in a real environment. The virtual simulator module 320 according to an embodiment of the disclosure may be modified by setting a function, a variable of the function, and the like of the virtual simulator module 320 to different values.

For example, the virtual simulator module 320 may include a function according to the following Equation 1.

$${P}_{e} ( γ , B , R ) = 1 - \frac{1}{1 + {e}^{{F}_{1} ( γ , B , R )} + 2 \cdot {e}^{{F}_{2} ( γ , B , R )}} \\ {F}_{1} ( γ , B , R ) = {k}_{1} + {k}_{2} \cdot γ + {k}_{3} \cdot R + {k}_{4} \cdot B + {k}_{S} \cdot γ B + {k}_{6} \cdot BR + {k}_{7} \cdot {B}^{{k}_{8}} \cdot {B}^{{k}_{9}} \\ {F}_{2} ( γ , B , R ) = {k}_{10} + {k}_{11} \cdot γ + {k}_{12} \cdot R \qquad [ Equation 1 ]$$

The virtual simulator module 320 according to an embodiment of the disclosure may output a value of Pe(γ, B, R) of Equation 1 as an output value. Values of k1 and k2 to k12, which are variables of a function of the virtual simulator module 320, may be adaptively set based on real data.

When the virtual simulator module 320 according to an embodiment of the disclosure operates according to a pre-trained artificial intelligence model, the virtual simulator module 320 may be modified by modifying at least one of a weight value, a node structure, or a bias value of the artificial intelligence model to minimize and/or reduce a difference between values 330 and 340.

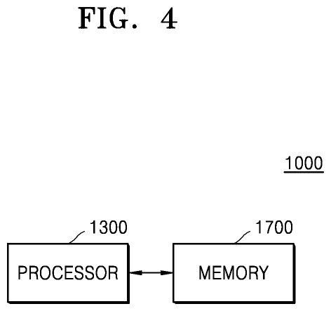

FIG. 4 is a block diagram illustrating an example configuration of the electronic device 1000, according to an embodiment of the disclosure.

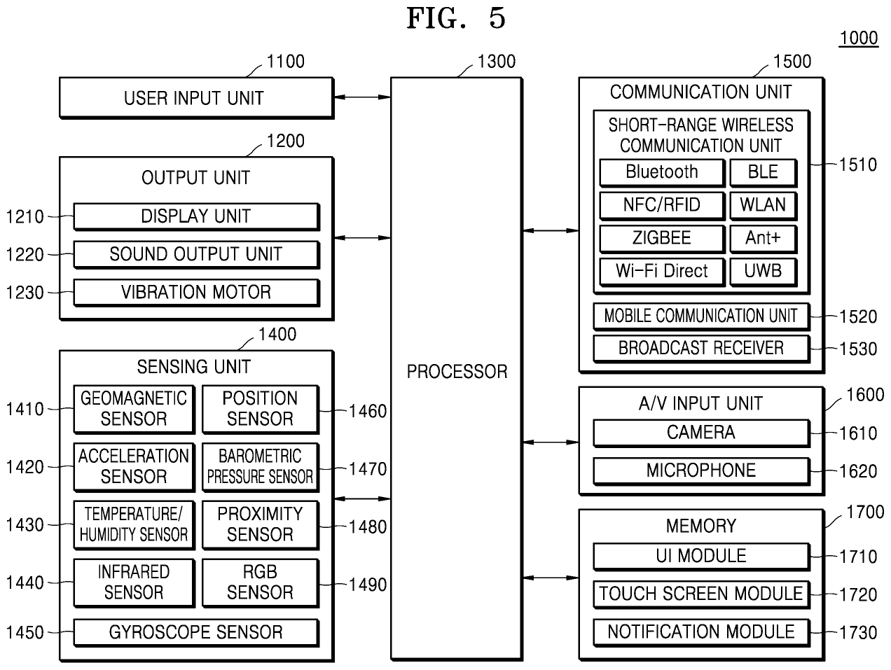

FIG. 5 is a block diagram illustrating an example configuration of the electronic device 1000, according to an embodiment of the disclosure.

Referring to FIG. 4, the electronic device 1000 may include a processor (e.g., including processing circuitry) 1300 and a memory 1700. However, not all the components illustrated in FIG. 4 are necessary components of the electronic device 1000. The electronic device 1000 may be implemented by more components or less components than the components illustrated in FIG. 4.

For example, as shown in FIG. 5, the electronic device 1000 according to an embodiment of the disclosure may further include a user input unit (e.g., including user input circuitry) 1100, an output unit (e.g., including output circuitry) 1200, a sensing unit (e.g., including various sensors) 1400, a communication unit (e.g., including communication circuitry) 1500, and an audio/video (A/V) input unit (e.g., including A/V input circuitry) 1600, in addition to the processor 1300 and the memory 1700.

The user input unit 1100 may include various circuitry for inputting data for a user to control the electronic device 1000. For example, the user input unit 1100 may include, but is not limited to, a keypad, a dome switch, a touch pad (a touch capacitive type, a pressure resistive type, an infrared beam sensing type, a surface acoustic wave type, an integral strain gauge type, a piezoelectric type, or the like), a jog wheel, a jog switch, or the like.

The user input unit 1100 according to an embodiment of the disclosure may obtain a first virtual simulator module and a second virtual simulator module, and may receive a user input for performing an operation based on the first and second virtual simulator modules. For example, an operation for selecting a carrier of the user entity 150 based on the first virtual simulator module and the second virtual simulator module may be performed based on a user input.

As another example, when an operation of transmitting data is performed in response to a user input, a virtual simulator module for predicting a data transmission error rate in relation to the operation of transmitting data may be obtained, and according to the obtained virtual simulator module, the operation of transmitting data may be performed based on a parameter set of an operation whose data transmission error rate is predicted to be the lowest.

The output unit 1200 may include various output circuitry and output an audio signal, a video signal, or a vibration signal, and the output unit 1200 may include the display unit 1210, a sound output unit 1220, and a vibration motor 1230.

The display unit 1210 may include a display and displays and outputs information processed by the electronic device 1000. According to an embodiment of the disclosure, the display unit 1210 may output information related to an operation of obtaining a virtual simulator module. For example, information related to an operation performed according to the virtual simulator module obtained according to an embodiment of the disclosure may be output.

When the display unit 1210 and a touch pad form a layer structure and thus include a touch screen, the display unit 1210 may also be used as an input device in addition to being used as an output device. The display unit 1210 may include at least one of a liquid crystal display, a thin film transistor-liquid crystal display, an organic light-emitting diode, a flexible display, a three-dimensional (3D) display, or an electrophoretic display. Also, the electronic device 1000 may include two or more display units 1210 according to an implementation type of the electronic device 1000.

The sound output unit 1220 may include various sound output circuitry and outputs audio data received from the communication unit 1500 or stored in the memory 1700.

The vibration motor 1230 may output a vibration signal. In addition, when a touch is input to a touch screen, the vibration motor 1230 may output a vibration signal.

According to an embodiment of the disclosure, the sound output unit 1220 and the vibration motor 1230 may output information related to an operation performed based on a virtual simulator module. For example, information related to a carrier selection operation or a data transmission operation, which is an operation performed according to the virtual simulator module obtained according to an embodiment of the disclosure, may be output.

The processor 1300 may include various processing circuitry and generally controls overall operations of the electronic device 1000. For example, the processor 1300 may take overall control of the user input unit 1100, the output unit 1200, the sensing unit 1400, the communication unit 1500, the A/V input unit 1600, and the like by executing programs stored in the memory 1700.

The electronic device 1000 may include at least one processor 1300. For example, the electronic device 1000 may include various types of processor such as, for example, and without limitation, at least one of a central processing unit (CPU), a graphics processing unit (GPU), a neural processing unit (NPU), or the like.

The processor 1300 may be configured to process commands of a computer program by performing basic arithmetic, logic, and input/output operations. The commands may be provided from the memory 1700 to the processor 1300 or may be received via the communication unit 1500 and provided to the processor 1300. For example, the processor 1300 may be configured to execute the commands according to program codes stored in a recording device such as memory.

The processor 1300 according to an embodiment of the disclosure may perform an operation of a plurality of operations using a simulator module and modeling module for virtually implementing an operation. The processor 1300 may obtain first performance information, which indicate performance of an operation, for each of the plurality of operations using the simulator module. Also, the processor 1300 may obtain second performance information for each of the plurality of operations based on the first performance information using the modeling module. The processor 1300 may perform an operation of the plurality of operations based on the first and second performance information obtained for each of the plurality of operations.

The processor 1300 according to an embodiment of the disclosure may obtain a plurality of virtual simulator modules trained based on real data, and may obtain at least one virtual simulator module from among the plurality of virtual simulator modules based on whether the plurality of virtual simulator modules are suitable for implementing an operation of a real environment.

The processor 1300 according to an embodiment of the disclosure may perform an operation in a real environment, based on an operation implemented by the at least one virtual simulator module.

For example, the processor 1300 may determine a parameter set for an operation based on the operation implemented by the at least one virtual simulator module, and may perform the operation in a real environment based on the determined parameter set. According to an embodiment of the disclosure, a plurality of operations may be virtually implemented based on a plurality of parameter sets using a virtual simulator module. Accordingly, a parameter set, at which an operation may be optimally performed, from among the plurality of parameter sets may be determined based on an output value of the virtual simulator module, which is a result of the plurality of operations that are virtually implemented. According to an embodiment, an optimum operation may be performed based on the determined parameter set.

The sensing unit 1400 may include various sensors and sense a state of the electronic device 1000 or a state around the electronic device 1000, and may transfer sensed information to the processor 1300.

The sensing unit 1400 may include, but is not limited to, at least one of a geomagnetic sensor 1410, an acceleration sensor 1420, a temperature/humidity sensor 1430, an infrared sensor 1440, a gyroscope sensor 1450, a position sensor (for example, a global positioning system (GPS)) 1460, a barometric pressure sensor 1470, a proximity sensor 1480, and/or an RGB sensor (illuminance sensor) 1490.

The communication unit 1500 may include various communication circuitry included in one or more components allowing the electronic device 1000 to communicate with a server 2000 or an external device (not shown). For example, the communication unit 1500 may include a short-range wireless communication unit 1510, a mobile communication unit 1520, and a broadcast receiver 1530.

The short-range wireless communication unit 1510 may include, but is not limited to, a Bluetooth communication unit, a Bluetooth Low Energy (BLE) communication unit, a near field communication unit, a wireless local area network (WLAN) (Wi-Fi) communication unit, a Zigbee communication unit, a Wi-Fi Direct (WFD) communication unit, an ultra wideband (UWB) communication unit, an Ant+ communication unit, or the like.

The mobile communication unit 1520 may include various communication circuitry and transmits a radio signal to and receives a radio signal from at least one of a base station, an external terminal, or a server on a mobile communication network. Here, the radio signal may include various types of data according to transmission and reception of a voice call signal, a video call signal, or a text/multimedia message.

The broadcast receiver 1530 may include various communication circuitry and receives a broadcast signal and/or broadcast-related information from outside the electronic device 1000 via a broadcast channel. The broadcast channel may include a satellite channel or a terrestrial channel. According to an embodiment of the disclosure, the electronic device 1000 may not include the broadcast receiver 1530.

According to an embodiment of the disclosure, the communication unit 1500 may transmit and receive data required to obtain a virtual simulator module. Also, the communication unit 1500 may access a wireless network via a carrier selected based on the virtual simulator module.

The A/V input unit 1600 may include various A/V input circuitry for inputting an audio signal or a video signal and may include a camera 1610, a microphone 1620, and the like. The camera 1610 may obtain an image frame of a still image, a moving image, or the like through an image sensor in a video call mode or a shooting mode. An image captured through the image sensor may be processed by the processor 1300 or a separate image processing unit (not shown).

The microphone 1620 receives an external sound signal that is input thereto and processes the sound signal into electrical sound data. For example, the microphone 1620 may receive, from a user, a sound input related to an operation of obtaining a virtual simulator module.

The memory 1700 may store programs for processing and control performed by the processor 1300 and may also store data that is input to or output from the electronic device 1000.

The memory 1700 according to an embodiment of the disclosure may store data required to obtain a virtual simulator module. For example, the memory 1700 may store real data related to an operation of a real environment.

The memory 1700 may include at least one of a flash memory type storage medium, a hard disk type storage medium, a multimedia card micro type storage medium, card type memory (for example, Secure Digital (SD) memory, eXtreme Digital (XD) memory, or the like), random access memory (RAM), static random access memory (SRAM), read-only memory (ROM), electrically erasable programmable read-only memory (EEPROM), programmable read-only memory (PROM), magnetic memory, a magnetic disk, or an optical disk.

The programs stored in the memory 1700 may be classified into a plurality of modules, for example, a UI module 1710, a touch screen module 1720, a notification module 1730, and the like, according to functions thereof.

The UI module 1710 may provide a specialized UI, a graphic user interface (GUI), or the like interworking with the electronic device 1000, on an application basis. The touch screen module 1720 may sense a touch gesture of the user on a touch screen and may transfer information about the touch gesture to the processor 1300. The touch screen module 1720 according to an embodiment of the disclosure may recognize and analyze a touch code. The touch screen module 1720 may be configured by separate hardware including a controller.

To sense a touch or a proximity touch with respect to the touch screen, various sensors may be arranged inside or near the touch screen. An example of a sensor for sensing a touch with respect to the touch screen includes a tactile sensor. The tactile sensor refers to a sensor sensing a contact with a particular object to an extent felt by a human or to a higher extent. The tactile sensor may sense various pieces of information, such as roughness of a contact surface, hardness of a contact object, and a temperature of a contact point.

The touch gesture of the user may include tap, touch and hold, double tap, drag, panning, flick, drag and drop, swipe, or the like.

The notification module 1730 may generate a signal for notifying the occurrence of an event of the electronic device 1000.

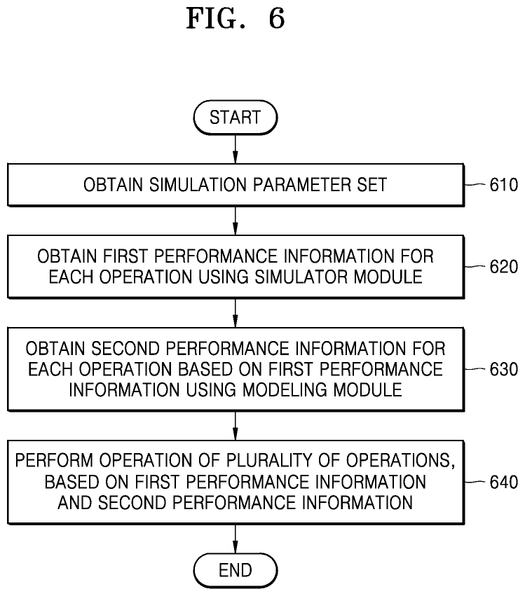

FIG. 6 is a flowchart illustrating an example method of performing an operation based on a virtual simulator module, according to various embodiments.

Referring to FIG. 6, in operation 610, the electronic device 1000 according to an embodiment of the disclosure may obtain a simulation parameter set for each of a plurality of operations to perform simulations for the plurality of operations. The simulation parameter set according to an embodiment of the disclosure may include parameters for obtaining first performance information by a simulator module simulating the operations. For example, in a case of an operation of accessing a wireless network via a carrier, parameters such as a packet size, a packet request interval, a hotspot distance ratio, and a hotspot UE ratio may be included. The disclosure is not limited to examples described above, the simulation parameter set may include various parameters for obtaining information related to performance of the simulated operations.

In operation 620, based on the simulation parameter set obtained in operation 610, the electronic device 1000 according to an embodiment of the disclosure may obtain the first performance information for each of the plurality of operations using the simulator module.

The first performance information according to an embodiment of the disclosure may include the input KPI 130 shown in FIG. 1, wherein the input KPI 130 may be obtained by the simulator module.

According to an embodiment of the disclosure, according to a result of an iterative training for minimizing a difference between the first information obtained by the simulator module and actually observed first performance information, a most suitable parameter set may be determined as a simulation parameter set for obtaining the first performance information. Training of the simulator module according to an embodiment of the disclosure may be performed according to at least one of a reinforcement learning or a training based on particle swarm optimization.

The first performance information obtained from a real environment according to an embodiment of the disclosure may include information indicating performance for an operation that is actually performed. According to an embodiment of the disclosure, operations according to different settings are performed several times to obtain the first performance information, whereby the first performance information may be obtained from the real environment.

In operation 630, the electronic device 1000 according to an embodiment of the disclosure may obtain second performance information for each of the plurality of operations, based on the first performance information obtained in operation 620, using a modeling module.

The second performance information according to an embodiment of the disclosure may include the target KPI 140 shown in FIG. 1, wherein the target KPI 140 may be obtained by the modeling module.

The modeling module according to an embodiment of the disclosure may be an artificial intelligence model pre-trained based on training data so as to obtain the second performance information from the first performance information, the training data including a pair of the first performance information and the second performance information that are obtained from a real environment.

The modeling module according to an embodiment of the disclosure may include new training data that is generated in response to at least one performance information included in the training data on which up-sampling is performed. The at least one performance information may include at least one of the first performance information or the second performance information.

The up-sampling according to an embodiment of the disclosure may be performed by generating new training data based on a value of performance information, from among values of the performance information included in the training data, where the number of the values of the performance information belonging to each of divided ranges is less than or equal to a reference value. According to an embodiment of the disclosure, a range of values of performance information may be divided into a plurality of ranges, and whether the number of the values of the performance information is less than or equal to a reference value may be identified, wherein the values of the performance information belong to each of the ranges.

The training data of the modeling module according to an embodiment of the disclosure may include a value labeled according to a divided range instead of a value of performance information, according to distribution characteristics of each performance information included in the training data. For example, because most of RRC drop rates of performance information have distribution characteristics having values close to 0, a range of 0-2% close to 0 may be divided into a larger number of ranges than what other ranges may be divided into. Also, the training data may include a labeled value indicating a range to which a value of an RRC drop rate belongs, instead of the value of the RRC drop rate.

In operation 640, the electronic device 1000 according to an embodiment of the disclosure may perform an operation of a plurality of operations, based on the first performance information and the second performance information. For example, the electronic device 1000 may determine a score for each of the plurality of operations based on the first performance information and the second performance information, and may perform an operation having a highest determined score. For example, a score for each operation may be determined to perform an operation in which a value indicating IP throughput of the first performance information is greater than or equal to a reference value. A penalty may be imposed on a score of an operation in which an RRC drop rate of the second performance information is greater than or equal to a reference value. The disclosure is not limited to examples described above, and the electronic device 1000 may determine and perform an operation of a plurality of operations according to various methods.

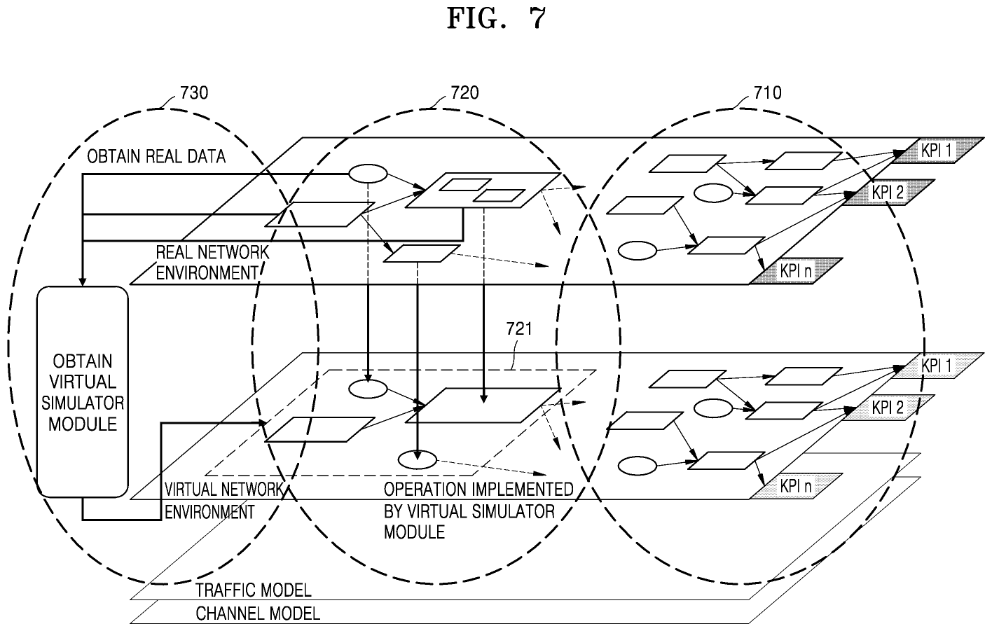

FIG. 7 is a diagram illustrating an example of simulating an operation of a network environment, according to various embodiments.

Referring to FIG. 7, the electronic device 1000 according to an embodiment of the disclosure may obtain a virtual simulator module for implementing an operation performed in a network environment, based on real data obtained from a real environment.

The operation of the network environment according to an embodiment of the disclosure may be performed according to a set condition, based on at least one KPI.

A KPI 710 according to an embodiment of the disclosure may exist with respect to the real network environment and the virtual network environment. The KPI 710 for the real network according to an embodiment of the disclosure may indicate an indicator for an operation performed in the real network, and the KPI 710 for the virtual network according to an embodiment of the disclosure may indicate an indicator for an operation, which is virtually implemented by the virtual simulator module, in the virtual network environment.

According to an embodiment of the disclosure, setting information for an operation to be performed in the real network environment or the virtual network environment is adjusted according to the KPI 710, whereby the operation may be performed with optimum performance.

In operation 720, an operation 721 of the virtual network environment according to an embodiment of the disclosure may be implemented by the virtual simulator module in the virtual network environment. The virtual simulator module according to an embodiment of the disclosure may be generated to obtain a KPI for an operation performed in the virtual network environment, based on an algorithm, model, function, or the like used to perform an operation of the real network environment.

In operation 730, according to an embodiment of the disclosure, the virtual simulator module may be obtained based on the real data obtained in relation to an operation performed in the real network environment. For example, the virtual simulator module is modified to obtain an output value (e.g., a result of an operation and KPI) according to the real data, based on an input value (e.g., a parameter set for an operation) according to the real data, whereby the virtual simulator module reflecting the real network environment may be obtained.

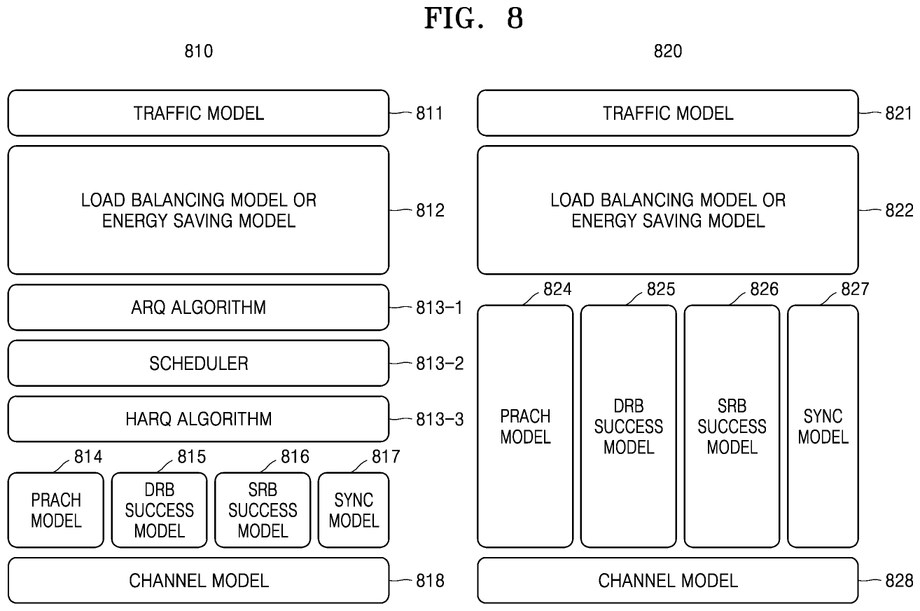

FIG. 8 is a diagram illustrating an example of simulating an operation of a network environment, according to various embodiments.

Referring to FIG. 8, the electronic device 1000 according to an embodiment of the disclosure may perform an operation of a network environment, according to a model illustrated in 810 or 820. The electronic device 1000 according to an embodiment of the disclosure may be a server or a base station, which processes data to allow an external terminal (not shown) to perform communication according to a request from the external terminal, or may be a device that may control the server or the base station.

At least one model included in 810 and 820 according to an embodiment of the disclosure may be used for the electronic device 1000 to perform a load balancing operation or an energy saving operation in the network environment.

The load balancing operation according to an embodiment of the disclosure refers to an operation of distributing a communication request from the external terminal to a plurality of servers or base stations. According to an embodiment of the disclosure, a communication request from at least one external terminal may be processed in a plurality of servers or base stations according to load balancing models 812 and 822.

Also, the energy saving operation according to an embodiment refers to an operation of turning off power of some devices among a server or a base station that processes a communication request from the external terminal, according to network traffic situation. According to an embodiment of the disclosure, power of a plurality of servers or base stations may be controlled according to energy saving models 812 and 822.

The load balancing models/energy saving models 812 and 822 according to an embodiment of the disclosure may implement a load balancing operation or an energy saving operation in a virtual environment, according to various traffic situations implemented in the virtual environment according to a traffic model 811 and a traffic model 821.

A probability of success of data transmission in various situations may be obtained based on a physical random access channel (PRACH) model 814, a PRACH model 824, data ratio bearer (DRB) success models 815 and 825, signaling radio bearer (SRB) success models 816 and 826, sync models 817 and 827, and channel models 818 and 828 according to an embodiment of the disclosure. An automatic repeat request (ARQ) algorithm 813-1, a scheduler 813-2, and a hybrid automatic repeat request algorithm (HARQ) 813-3 according to an embodiment of the disclosure may perform an operation of controlling an error of data in a virtual environment.

As shown in 810, the ARQ algorithm 813-1, the scheduler 813-2, and the HARQ algorithm 813-3 according to an embodiment of the disclosure may be individually performed, or as shown in 820, a probability of success of data transmission may be obtained, including an operation of controlling an error of data according to the ARQ algorithm 813-1, the scheduler 813-2, and the HARQ algorithm 813-3 in each of the PRACH model 824, the DRB success model 825, the SRB success model 826, and the sync model 827.

According to an embodiment of the disclosure, a load balancing operation or an energy saving operation may be implemented by the load balancing models/energy saving models 812 and 822 in a virtual environment, based on information related to a situation where data, which may be obtained by the ARQ algorithm 813-1, the scheduler 813-2, the HARQ algorithm 813-3, the PRACH models 814 and 824, the DRB success models 815 and 825, the SRB success models 816 and 826, the sync models 817 and 827, and the channel models 818 and 828, is transmitted. For example, a value obtained based on the ARQ algorithm 813-1, the scheduler 813-2, the HARQ algorithm 813-3, the PRACH models 814 and 824, the DRB success models 815 and 825, the SRB success models 816 and 826, the sync models 817 and 827, and the channel models 818 and 828 is used as an input value for the load balancing models/energy saving models 812 and 822, whereby a load balancing operation or an energy saving operation may be implemented.

According to an embodiment of the disclosure, the PRACH models 814 and 824, the DRB success models 815 and 825, the SRB success models 816 and 826, and the sync models 817 and 827 as well as the load balancing models/energy saving models 812 and 822 may be obtained according to a method of obtaining a virtual simulator module according to an embodiment of the disclosure.

The ARQ algorithm 813-1, the scheduler 813-2, the HARQ algorithm 813-3, the PRACH models 814 and 824, the DRB success models 815 and 825, the SRB success models 816 and 826, the sync models 817 and 827, and the channel models 818 and 828 and the load balancing models/energy saving models 812 and 822 according to an embodiment of the disclosure may be continuously modified based on real data according to a method of obtaining a virtual simulator module according to an embodiment of the disclosure.

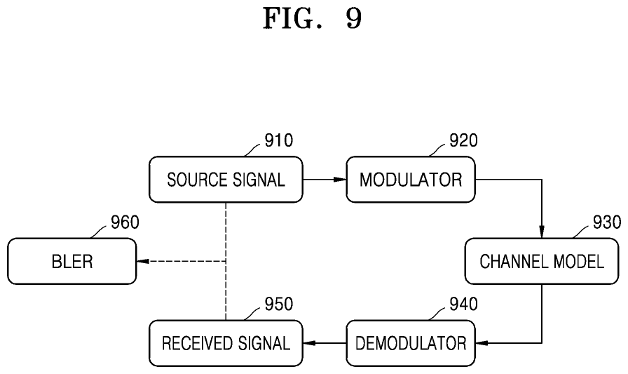

FIG. 9 is a diagram illustrating an example of detecting an error rate for a data transmission operation of a virtual environment using a virtual simulator module, according to various embodiments.

Referring to FIG. 9, a block error rate (BLER) 960 according to an embodiment of the disclosure may be determined based on a difference between a source signal 910 transmitted by a link level simulator and a received signal 950.

The source signal 910 according to an embodiment of the disclosure may include a signal transmitted in a virtual network environment, may be arbitrarily generated, and is a signal on which a transmission operation is not actually performed. The received signal 950 according to an embodiment of the disclosure may be obtained in response to the source signal 910 being transmitted by a modulator 920, a channel model 930, and a demodulator 940 in the virtual network environment.

The modulator 920 according to an embodiment of the disclosure may perform an operation of appropriately converting the source signal 910 to allow the source signal 910 to be transmitted to a network environment. For example, data of the source signal 910 may be transmitted, after being converted in a form that may include a small amount of noise when transmitted in a network environment.

The channel model 930 according to an embodiment of the disclosure may implement a network environment in which transmission is performed. For example, according to the channel model 930, the network environment may be virtually implemented to allow noise, which may be included during a transmission process, to be added to the source signal 910 in response to data being transmitted.

The demodulator 940 according to an embodiment of the disclosure may convert again a signal received via the network environment implemented by the channel model 930, and thus, may perform an operation of outputting the received signal 950, which is a signal corresponding to the source signal 910. The demodulator 940 according to an embodiment of the disclosure may obtain the received signal 950 by converting the received source signal 910 to minimize and/or reduce noise included in the received signal 950 in consideration of the noise generated during a transmission process in the source signal 910.

The BLER 960 according to an embodiment of the disclosure may obtain a data transmission error rate by obtaining a difference between the source signal 910 and the received signal 950. For example, when the source signal 910 includes less noise generated by the channel model 930, a difference between the source signal 910 and the received signal 950 decreases, whereby a data transmission error rate may decrease.

According to an embodiment of the disclosure, performance of the modulator 920 and the demodulator 940 may be determined according to an error rate obtained from the BLER 960. For example, when an error rate of the BLER 960 is low, it may be determined that the source signal 910 is appropriately converted by the modulator 920, such that less noise may be included in the source signal 910. Also, when an error rate of the BLER 960 is low, it may be determined that the source signal 910 is appropriately converted by the demodulator 940, such that noise included in the source signal 910 received via the channel model 930 may be minimized and/or reduced.

According to an embodiment of the disclosure, a component of the modulator 920 or the demodulator 940 may be modified, such that an error rate of the BLER 960 may be lowered according to performance of the modulator 920 and the demodulator 940, the performance being determined based on the error rate obtained from the BLER 960. For example, a component (e.g., parameter) of a function or a component of a pre-trained artificial intelligence model, which is used to perform an operation of the modulator 920 or the demodulator 940, may be modified to lower an error rate of the BLER 960.

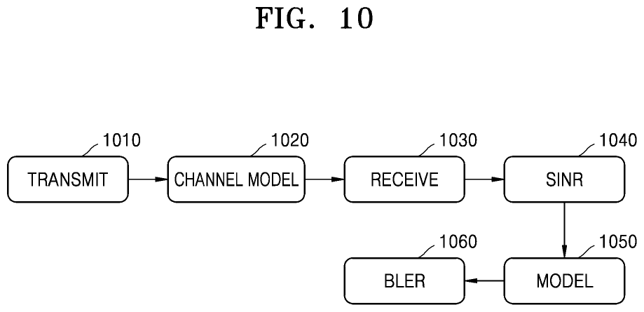

FIG. 10 is a diagram illustrating an example of detecting an error rate for an operation of a virtual environment using a virtual simulator module, according to various embodiments.

Referring to FIG. 10, a BLER 1060 according to an embodiment of the disclosure may be determined based on a received signal 1030, without information about a transmitted signal 1010, by a system level simulator.

According to an embodiment of the disclosure, the system level simulator transmits the data signal 1010 in a network environment, and a value of a SINR 1040 may be obtained for the signal 1030 received through a network environment implemented by a channel model 1020. A model 1050 according to an embodiment of the disclosure may output the BLER 1060, which is an error rate, using the value of the SINR 1040 as an input value.

Therefore, according to the system level simulator according to an embodiment of the disclosure, a receiving side may obtain the BLER 1060, based on the value of the SINR 1040, without information about the transmitted signal 1010.

However, the model 1050 of the system level simulator according to an embodiment of the disclosure may be modified based on a value of the BLER 960 and a SNR or SINR of the received signal 950, which are obtained according to the source signal 910 virtually implemented by the link level simulator of FIG. 9, in consideration of accuracy of the value of the BLER 1060 obtained without information about the transmitted signal 1010. For example, the model 1050 may be modified to obtain the BLER 1060 corresponding to the SINR 1040 of FIG. 10 according to a corresponding relationship between a value of a SNR or SINR of the received signal 950 of FIG. 9 and a value of the BLER 960.

However, when the model 1050 of the system level simulator according to an embodiment of the disclosure may be adaptively modified based on real data, information about the transmitted signal 1010 may be considered by the model 1050 of the system level simulator as a network environment from which the real data is obtained. Therefore, the model 1050 of the system level simulator is modified based on the real data according to an embodiment of the disclosure, whereby accuracy of a value of the BLER 1060 obtained from the model 1050 without information about the transmitted signal 1010 may be sufficiently secured without considering a value of the BLER 960 of the link level simulator of FIG. 9.

The model 1050 according to an embodiment of the disclosure may correspond to the virtual simulator module 320 shown in FIG. 3. For example, the SINR 1040 input to the model 1050 of FIG. 10 may correspond to a value input as a channel state (γ) in FIG. 3. Therefore, the model 1050 according to an embodiment of the disclosure may include an artificial intelligence model or a function, at which the BLER 1060 may be output based on the SINR 1040, such as the virtual simulator module 320 of FIG. 3.

Also, the model 1050 according to an embodiment of the disclosure may be adaptively modified based on real data, such as the virtual simulator module 320 of FIG. 3. For example, elements (e.g., a configuration of a function, a parameter of a function, a component of an artificial intelligence model) of an operation of the model 1050 may be modified to output the BLER 1060 included in real data based on the SINR 1040 included in the real data.

Therefore, the virtual simulator module according to an embodiment of the disclosure is adaptively modified based on real data, and thus, may provide excellent performance compared to virtual simulator modules in the related art which operate according to a function including a fixed parameter.

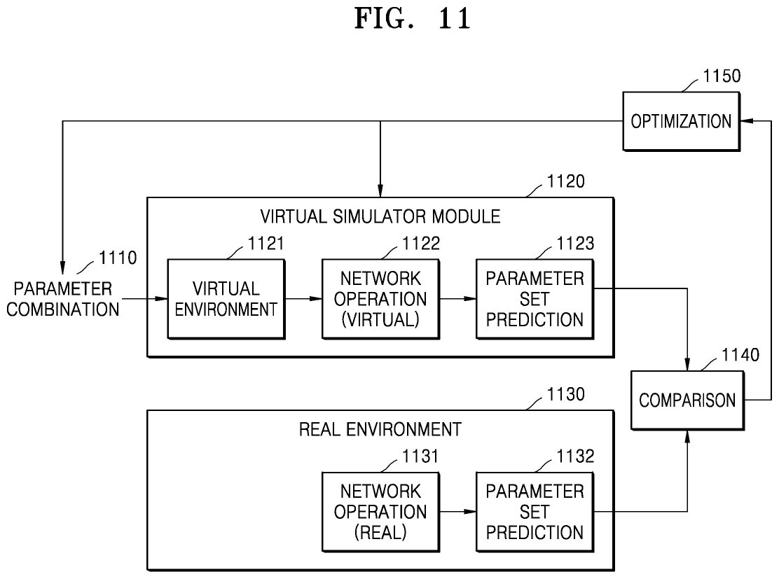

FIG. 11 is a diagram illustrating an example of predicting a parameter set using a virtual simulator module, according to various embodiments.

Referring to FIG. 11, a virtual simulator module (e.g., including various processing circuitry and/or executable program elements) 1120 may predict a parameter set 1123 including at least one parameter, based on a parameter combination 1110 including at least one parameter observed in a real environment. The parameter set 1123 predicted according to an embodiment of the disclosure may correspond to a parameter set 1132 that may be predicted according a network operation 1131 performed in a real environment 1130.

The parameter combination 1110 according to an embodiment of the disclosure may be used in the virtual simulator module 1120 to virtually implement a real environment. The parameter combination 1110 according to an embodiment of the disclosure may include a combination of at least one parameter suitable for virtually implementing a real environment and predicting a parameter set, from among various parameters that may be observed in the real environment, for example, that may be obtained by the electronic device 1000.

According to an embodiment of the disclosure, the parameter set 1123 may be predicted based on a result of performing a virtual network operation 1122 in a virtual environment 1121. The virtual simulator module 1120 according to an embodiment of the disclosure may output the parameter set 1123 predicted from a pre-trained artificial intelligence model. The artificial intelligence model according to an embodiment of the disclosure may implement the virtual environment 1121 using the parameter combination 1110 as an input, and may output the parameter set 1123 by performing the virtual network operation 1122. The disclosure is not limited to the artificial intelligence model, and the parameter set 1123 may be predicted by a pre-set function.

A function or artificial intelligence model and the parameter combination 1110, which are used by the virtual simulator module 1120 according to an embodiment of the disclosure to predict the parameter set 1123, may be optimized based on the parameter set 1132 obtained from the real environment 1130 (1150). The parameter set 1132 according to an embodiment of the disclosure may be obtained based on a result of actually performing the network operation 1131 in the real environment 1130.

According to an embodiment of the disclosure, the virtual network operation 1122 and the network operation 1131 performed in the real environment 1130 and the virtual environment 1121 are not limited to network operations, and may include various types of operations.

According to an embodiment of the disclosure, the parameter set 1132 is compared with the parameter set 1123 predicted by the virtual simulator module 1120 (1140), whereby optimization 1150 may be performed to minimize and/or reduce a difference between the parameter sets 1123 and 1132. For example, the optimization 1150 may be performed by modifying a function or an artificial intelligence model to minimize and/or reduce a difference between parameter sets 1123 and 1132 or changing at least one parameter included in the parameter combination 1110 to another parameter.

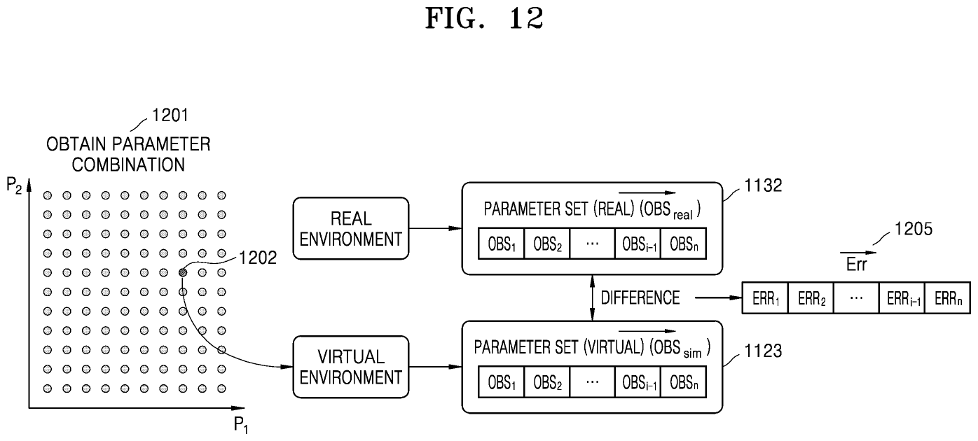

FIG. 12 is a diagram illustrating an example of obtaining the parameter combination 1110 for predicting the parameter set 1123, according to various embodiments.

Referring to FIG. 12, in 1201, the parameter set 1123 in a virtual environment may be obtained based on any one of a parameter combination 1202 from among combinations of various parameters. The parameter combination 1202 according to an embodiment of the disclosure is a value observed in a real environment and may be used to implement a virtual environment. The parameter combination 1202 according to an embodiment of the disclosure may include at least one parameter that may be observed in the real environment.

For example, when the parameter combination 1202 includes parameters of P1 and P2 that are different from each other, P1 and P2 may be determined as a combination of various types of parameters, as shown in 1201. For example, the parameter combination 1202 may include various types of parameters such as the number of devices using a network, a size of a packet that is transmitted and received in a network, and the like in a real environment. According to an embodiment of the disclosure, the parameter set 1123 of the virtual environment may be obtained based on one (e.g., the parameter combination 1202) from among combinations of various types of parameters. The disclosure is not limited thereto, and the parameter combination 1202 may be obtained as a combination of various numbers of parameters.

The parameter sets 1123 and 1132 of the virtual environment and the real environment according to an embodiment of the disclosure include different types of at least one parameter value such as OBS1 and OBS2 as shown in illustrated example, and thus, may be expressed as a value in the form of a vector. Parameter values such as OBS1 and OBS2 included in the parameter set 1123 of the virtual environment and the parameter set 1132 of the real environment according to an embodiment of the disclosure may include values corresponding between each of the parameter sets 1123 and 1132.

According to an embodiment of the disclosure, error information 1205, which is a value indicating a difference between the parameter sets 1123 and 1132, may be obtained in the form of a vector. For example, the error information 1205 may be obtained as a value indicating a difference between the parameter sets 1123 and 1132, according to a L2 distance (Euclidean distance formula). The disclosure is not limited thereto, and the error information 1205 indicating a difference between the parameter sets 1123 and 1132 may be obtained in various forms according to various methods.

According to an embodiment of the disclosure, to minimize and/or reduce a size of the error information 1205, an artificial intelligence model or function used in the parameter combination 1202 and the virtual simulator module 1120 may be modified.

According to an embodiment of the disclosure, a virtual simulator module used to implement a virtual environment may be used to select and perform a more appropriate operation from among a plurality of operations.

The device-readable storage media may be provided in the form of non-transitory storage media. The “non-transitory storage media” may refer, for example, to a tangible device and may not include a signal (e.g., electromagnetic wave), and the term does not distinguish between a case where data is stored semi-permanently in a storage media and a case where data is stored temporarily in a storage media. For example, the “non-transitory storage media” may include a buffer in which data is temporarily stored.

According to an embodiment of the disclosure, the methods according to the embodiments disclosed herein may be provided while included in a computer program product. The computer program product may be traded as merchandise between a seller and a purchaser. The computer program product may be distributed in the form of a device-readable storage medium (e.g., compact disc read only memory (CD-ROM)), or may be distributed (e.g., downloaded or uploaded) online through an application store (e.g., Play Store™) or directly between two user devices (e.g., smartphones). In the case of the online distribution, at least a part of the computer program product (e.g., downloadable app) may be temporarily stored in a device-readable storage medium such as a server of a manufacturer, a server of an application store, or a memory of a relay server, or may be temporarily generated.

In addition, the term such as “ . . . unit” or “ . . . portion” used herein may refer to a hardware component such as a processor or a circuit, and/or a software component executed by the hardware component such as a processor.

It will be understood by one of ordinary skill in the art that the embodiments of the disclosure are provided for illustration and may be implemented in different ways without departing from the spirit and scope of the disclosure. Therefore, it should be understood that the foregoing embodiments of the disclosure are provided for illustrative purposes only and are not to be construed in any way as limiting the disclosure. For example, each component described as a single type may be implemented in a distributed manner, and similarly, components described as being distributed may be implemented as a combined type.

While the disclosure has been illustrated and described with reference to various example embodiments, it will be understood that the various example embodiments are intended to be illustrative, not limiting. It will be further understood by those skilled in the art that various changes in form and detail may be made without departing from the true spirit and full scope of the disclosure, including the appended claims and their equivalents.

What is claimed is:

1. A method, performed by an electronic device, of performing an operation based on a virtual simulator module, the method comprising:
obtaining a simulation parameter set for each of a plurality of operations for performing simulations with respect to the plurality of operations;
obtaining first performance information for each operation using a simulator module, wherein the first performance information indicates performance of an operation simulated based on the simulation parameter set;
obtaining second performance information for each operation based on the first performance information using a modeling module, wherein the second performance information indicates performance of the operation simulated in the simulator module; and
performing an operation of the plurality of operations, based on the first performance information and the second performance information.

2. The method of claim 1, wherein the simulator module is obtained by iterative training to reduce a difference between the first performance information obtained from a real environment and the first performance information output by the simulator module.

3. The method of claim 2, wherein the simulator module is trained based on at least one of training based on particle swarm optimization (PSO) or reinforcement learning.

4. The method of claim 1, wherein the modeling module includes an artificial intelligence model pre-trained based on training data to obtain the second performance information from the first performance information, the training data comprising a pair of the first performance information and the second performance information obtained from a real environment.

5. The method of claim 4, wherein the modeling module includes an artificial intelligence model trained based on new training data generated by up-sampling at least one performance information included in the training data.

6. The method of claim 5, wherein the up-sampling comprises: dividing a range of values of the at least one performance information into a plurality of ranges, and generating new training data based on a value of the at least one performance information, wherein the value of the at least one performance information belongs to a range in which the number of values of the at least one performance information is equal to or less than a reference value, from among the plurality of ranges.

7. The method of claim 4, wherein a range of values of at least one performance information is divided into a plurality of ranges based on distribution characteristics of the at least one performance information included in the training data, and
the training data comprises a labeled value indicating a range to which a value of the at least one performance information belongs as the value of the at least one performance information.

8. An electronic device configured to perform an operation based on a virtual simulator module, the electronic device comprising:
a memory storing one or more instructions; and
at least one processor configured to execute the one or more instructions stored in the memory,
wherein the instructions, when executed by the at least one processor cause the at least one processor to control the electronic device to:
obtain a simulation parameter set for each of a plurality of operations for performing simulations with respect to the plurality of operations,
obtain first performance information for each operation using a simulator module, wherein the first performance information indicates performance of an operation simulated based on the simulation parameter set,
obtain second performance information for each operation based on the first performance information using a modeling module, wherein the second performance information indicates performance of the operation simulated in the simulator module, and
perform an operation of the plurality of operations based on the first performance information and the second performance information.

9. The electronic device of claim 8, wherein the simulator module is obtained by iterative training to reduce a difference between the first performance information obtained from a real environment and the first performance information output by the simulator module.

10. The electronic device of claim 9, wherein the simulator module is trained based on at least one of training based on particle swarm optimization (PSO) or reinforcement learning.

11. The electronic device of claim 8, wherein the modeling module includes an artificial intelligence model pre-trained based on training data to obtain the second performance information from the first performance information, the training data comprising a pair of the first performance information and the second performance information obtained from a real environment.

12. The electronic device of claim 11, wherein the modeling module includes an artificial intelligence model trained based on new training data generated by up-sampling at least one performance information included in the training data.

13. The electronic device of claim 12, wherein the up-sampling comprises: dividing a range of values of the at least one performance information into a plurality of ranges, and generating new training data based on a value of the at least one performance information, wherein the value of the at least one performance information belongs to a range in which the number of values of the at least one performance information is equal to or less than a reference value, from among the plurality of ranges.

14. The electronic device of claim 11, wherein a range of values of at least one performance information is divided in to a plurality of ranges based on distribution characteristics of the at least one performance information included in the training data, and
the training data comprises a labeled value indicating a range to which a value of the at least one performance information belongs as the value of the at least one performance information.

15. A non-transitory computer-readable recording medium having recorded thereon a program for implementing the method of claim 1.
